(19) United States
(12) Patent Application Publication
(10) Pub. No.: US 2009/0139593 A1
(43) Pub. Date: Jun. 4, 2009

(54) Flexible Insert Tube for the Lining of Pipelines and of Ducts, in Particular of Sewers

(76) Inventor: Robert Papp, Motzingen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/083,933

(22) PCT Filed: Nov. 13, 2006
(86) PCT No.: PCT/EP2006/010853

§ 371 Date: Apr. 22, 2008

(30) Foreign Application Priority Data
Nov. 14, 2005 (DE) 10 2005 056 266.3
Nov. 14, 2005 (DE) 20 2005 018 452.7

(51) Int. Cl. F16L 55/165

(52) U.S. Cl. 138/98; 138/124; 138/97; 405/150.1; 405/184.2

(57) ABSTRACT

The invention relates to a flexible insert tube (1) for the lining of pipelines (2) and of ducts, in particular of sewers (4), where the flexible insert tube (1) has at least two sublayers (8, 10, 22), of which at least one first sublayer (8, 12) has fibres composed of an inorganic material and can be impregnated by a hardenable reactive composition, characterized in that in the direction from the inside to the outside, based on a longitudinal axis (6) of the flexible insert tube (1), a first inner sublayer (8) is followed by a further sublayer (10), which can be impregnated by the hardenable reactive composition, and whose proportion of fibres composed of an inorganic material is less than 100%.

The invention relates to a flexible insert tube for the lining of pipelines and of ducts, in particular of sewers, according to the preamble of claim 1.

Damaged lines or ducts, in particular sewers or the pertinent pipelines, can generally be rehabilitated by replacement of damaged duct or pipe sections. The associated costs and downtimes in many cases are not acceptable for underground ducts or pipelines. For this reason a technology has been developed in which a flexible insert tube is pulled into the duct to be rehabilitated. The flexible insert tube is impregnated with a curable reaction mass and, after pulling into the duct being rehabilitated, is brought into contact with the inside of the duct. Then the reaction mass is cured and the cured flexible insert tube forms a liquid-tight and generally also gastight pipeline within the duct.

Flexible insert tubes such as these are known for example from WO 00/50801 A2. The known flexible insert tube has several layers which are each formed from glass fibers and are impregnated with a curable resin. Typical lengths of these flexible insert tubes are between 30 and 60 m, but can also be up to 250 m and more. The diameter of the ducts to be rehabilitated is typically between 100 and 1200 mm, but can also be more or less.

With the known flexible insert tubes, ducts can be rehabilitated in a very high quality and in the cured state the flexible insert tubes have extremely high chemical and mechanical resistance.

The object of the invention is to make available a flexible insert tube which is still further improved with respect to economic efficiency and functionality. In one embodiment, at high chemical and/or mechanical resistance, the production costs for the flexible insert tube are to be reduced. In another embodiment the installation properties are to be further improved.

This object is achieved by the flexible insert tube specified in claim 1. Special embodiments of the invention are specified in the dependent claims.

In a flexible insert tube for lining of pipelines and ducts, in particular of sewers, the flexible insert tube having at least two layers, of which at least the first layer has fibers of inorganic material and can be impregnated with a curable reaction mass, the object is achieved in that in the direction from the inside to the outside, relative to the longitudinal axis of the flexible insert tube, the inner first layer is connected to another layer which can be impregnated with the curable reaction mass and which has a proportion of fibers of inorganic material which is less than 100%.

While for the known flexible insert tube there are several layers of identical composition on top of one another, in this invention the layers located on top of one another are of different material composition. Thus, from the inside to the outside the first layer which has fibers of inorganic material is joined to another layer with fibers which are made preferably entirely of an organic material, for example of polypropylene filaments or polyester filaments. Altogether there can be several layers of different composition on top of one another, and the thickness of the different layers can be different.

In one embodiment the first layers with fibers of an inorganic material alternate with other layers with a proportion of fibers of an inorganic material which is less than 100%, in particular such other layers with fibers consisting of polymer plastic fibers. In one embodiment the flexible insert tube has a three-layer structure with an inner first layer, an outer first layer and another layer in between. On the inside and/or the outside of the flexible insert tube there can be a liquid-tight tubing film so that the layers of the flexible insert tube are enclosed between the inner plastic tube and the outer plastic tube. By adding the curable reaction mass between the inner and outer plastic tubing the layers can be impregnated, i.e., saturated with the curable reaction mass.

The required mechanical and/or chemical resistance can be made available in a controlled manner by the sandwich structure of layers of different material composition according to the invention at the sites at which it is required in the particular application. Thus, for example, the first layers with the fibers of inorganic material which can be formed, for example, by glass fibers, make available high mechanical and/or chemical resistance and can therefore be used in particular as the inner and outer layer of the flexible insert tube. Instead of glass fibers, other fibers of inorganic material can also be used, in particular also carbon fibers or the like.

In one embodiment the alignment of the fibers of the first layer is predominantly or completely in the longitudinal direction and/or in the peripheral direction, each referenced to the longitudinal axis of the flexible insert tube. In this way high tensile strength of the flexible insert tube in the longitudinal direction and/or in the peripheral direction is ensured, especially in the cured state. The first layer can be composed of several partial layers, of which, for example, a first partial layer has predominantly or completely fibers which are aligned in the longitudinal direction, and a second partial layer has predominantly or completely fibers which are aligned in the peripheral direction. The two or more partial layers can be connected among one another by way of stitching threads. It is also possible for one or more first layers to have predominantly or completely fibers which are aligned in the longitudinal direction, while one or more other first layers have predominantly or completely fibers which are aligned in the peripheral direction.

Since in many applications high mechanical and/or chemical resistance is not necessary over the entire thickness of the flexible insert tube, for the material of the other layer between the inner and the outer first layer, a material of lower quality with respect to mechanical and/or chemical resistance can be used. For example, for this purpose nonwovens, felts, woven fabrics, knits or the like of polymer plastic threads can be used, for example polyester-containing or polypropylene-containing nonwovens or felts. If necessary, they can also have a proportion of fibers of inorganic material, in particular a proportion of less than 50% by weight and preferably less than 10% by weight, in many cases the proportion of fibers of inorganic material in the other layer can also be equal to zero. The use of other materials which can be impregnated for the other layer, for example also of open-pore foams, is also possible.

In one embodiment the different layers are all impregnated with the same curable reaction mass, for example an artificial resin, such as a polyester resin. In one version the composition of the resin is chosen such that curing takes place by ultraviolet radiation, preferably by radiation in the wavelength range between 350 and 450 nm, in particular between 380 and 420 nm. Furthermore, the composition of the resin can be chosen such that curing takes place thermally with hot water or an air-steam mixture. The exact curing curve is matched to the resin formulation. The heat-up rates and/or holding times at a certain temperature, accordingly the temperature-time relationship, are matched to the composition of the resin.

In one version, especially mechanically high tensile strength in the longitudinal direction and/or in the peripheral direction, relative to the longitudinal axis of the flexible insert tube, is ensured by the first layers. In comparison, the corresponding tensile strength in the longitudinal direction and/or peripheral direction of the other layer is less. If necessary, this can be compensated in any case in part also by the proportion of the curable reaction mass which is absorbed by the other layer being higher than the percentage of the curable reaction mass which has been absorbed by the first layer. Another advantage is that the other layer forms a spacer for the first layers adjoining inside and outside. In this way, with a proportion of fibers of inorganic material which is less compared to known flexible insert tubes, flexible insert tubes can be produced which have sufficient mechanical and/or chemical resistance, which at the same time guarantee the minimum wall thickness required after curing of the flexible insert tube, and which are still economical to produce and easy to draw into the duct to be rehabilitated.

Between the first layer and the other layer a single-ply layer of plastic polymer threads can be inserted, especially threads of polypropylene. The other layer can be formed for example from a polyester needle film. In one embodiment the costs for the other layer are less than the costs for a first layer, by which the costs of material use for the flexible insert tube are reduced.

In one embodiment the thickness of the other layer is greater than the thickness of the first layer. The entire wall thickness of the flexible insert tube in the cured state is, for example between 2 and 25 mm or between 3 and 30 mm. For many applications a wall thickness range between 5 and 25 mm is sufficient. In one embodiment the wall thickness can be formed, for example, by an inner first layer and an outer first layer with a wall thickness of 1 mm each and an intermediate additional layer with a wall thickness of 3 mm. These different wall thicknesses in the cured state are also found in the uncured state of the flexible insert tube by the correspondingly different thicknesses of the first and the other layers.

When using a suitable curable reaction mass, shrinkage occurs in the course of curing as a result of the polymerization which takes place. In one embodiment the thickness of the other layer is at least 1.5 times, preferably at least twice, the thickness of the first layer. In another embodiment the thickness of the other layer is more than 50% of the total wall thickness of the flexible insert tube. Depending on the application, the thickness of the other layer, for several other layers the sum of the thicknesses of the other layers, can be more than 80% or even more than 90% of the entire wall thickness of the flexible insert tube.

Other advantages, features and details of the invention will become apparent from the dependent claims and the following description, in which several embodiments are described in detail with reference to the drawings. In this connection the features mentioned in the claims and in the specification can be essential for the invention individually or in any combination.

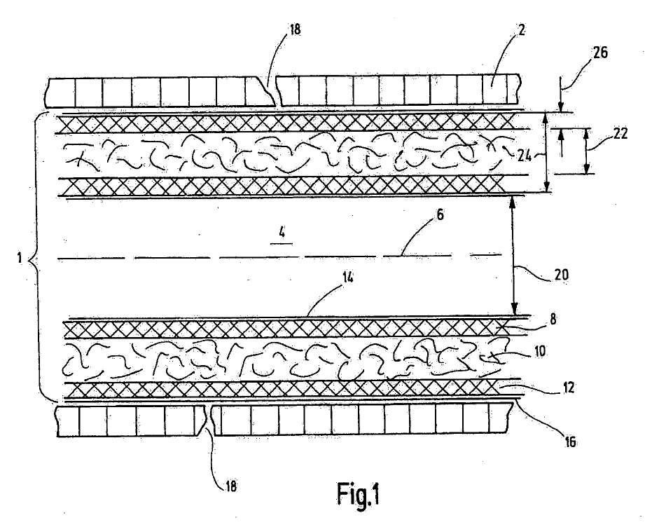

FIG. 1 shows a longitudinal section through a flexible insert tube according to the invention for lining a pipeline.

FIG. 1 shows a longitudinal section through a flexible insert tube 1 according to the invention for lining a pipeline 2 which forms an underground sewer 4. In this embodiment the flexible insert tube 1 has a total of three layers. A first layer 8 which is the inner layer with respect to the longitudinal axis 6 of the flexible insert tube 1 is formed from a glass fiber braid, a proportion of more than 50% of the glass fibers running either parallel to the longitudinal axis 6 or in the peripheral direction thereto. In this way, the flexible insert tube 1 according to the invention has high tensile strength in the longitudinal direction and/or in the peripheral direction. The first inner layer 8 can also be formed completely by glass fibers which are aligned either in the longitudinal direction or in the peripheral direction.

In the direction from the inside to the outside the inner first layer 8 is joined to another layer 10 which is formed from a nonwoven or felt of polyester threads or polypropylene threads. The other layer 10 can be formed in particular entirely from polyester threads or polypropylene threads which form a corresponding nonwoven or felt. Instead of one such nonwoven or felt, other braiding, woven fabric, knit or the like can be used and can be impregnated with a curable reaction mass. Radially on the outside it is joined to the outer first layer 12 which in turn is formed by braiding, woven fabric, knit or the like which is impregnated with a curable reaction mass.

In the direction to the inside, the inner first layer 8 is connected to an inner, liquid-tight plastic tube 14 which is removed after curing. Radially on the outside the outer first layer 12 is covered by an outer, liquid-tight plastic tube 16. In the cavity which forms between the inner plastic tube 14 and the outer plastic tube 16 the not yet cured reaction mass is added and thus the layers 8, 10, 12 are impregnated. In this state the flexible insert tube 1 is pulled into the pipeline to be rehabilitated and with its outer plastic tube comes into contact with the inside of the pipeline 2.

After curing the flexible insert tube 1, which takes place, for example, by irradiation with ultraviolet rays with a wavelength of approximately 400 mm, the flexible insert tube 1 forms a chemically and/or mechanically high-strength inner pipeline and in particular seals breaks or holes 18 in the pipeline 2 to be rehabilitated. The outer plastic tube 16 comes into close contact with the pipeline 2 so that the reduction of the inside width 20 of the remaining sewer 4 is generally at least 50%, preferably at least 80% of the corresponding inside width of the original pipeline 2. In FIG. 1, solely for reasons of clarity, the inside width 20 of the remaining sewer 4 is shown comparatively small.

The thickness 22 of the other layer 10 in the illustrated embodiment is approximately 3 mm. The thickness 26 of the first layers 8, 12 is conversely approximately 1 mm respectively so that the total thickness or wall thickness 24 of the flexible insert tube 1 is approximately 5 mm.

FIG. 1 shows only by way of example a layer sequence A (first layer)-B (other layer)-A (first layer). Accordingly, structures such as for example A-B-B-A, A-B-A-B-A, etc., can also be implemented, and the thicknesses (26) of the first layers can also be different. In many cases it will be advantageous, however, to make the inner first layer (8) and the outer first layer (12) relatively thick compared to first layers which may additionally be present, since the inner and outer layer experiences the highest chemical and mechanical stresses.

1. A flexible insert tube (1) for the lining of pipelines (2) and of ducts, in particular of sewers (4), the flexible insert tube (1) having at least two layers (8, 10, 22), of which at least the first layer (8, 12) has fibers of inorganic material and can be impregnated with a curable reaction mass, characterized in that in the direction from the inside to the outside, relative to the longitudinal axis (6) of the flexible insert tube (1), the inner first layer (8) is connected to another layer (10) which can be impregnated with the curable reaction mass and which has a proportion of fibers of inorganic material which is less than 100%.

2. The flexible insert tube (1) according to claim 1, wherein in the direction from the inside to the outside the other layer (10) is connected to an outer first layer (12) which has fibers of inorganic material.

3. The flexible insert tube (1) according to claim 1 or 2, wherein the thickness (22) of the other layer (10) is greater than the thickness of the first layer (8, 12).

4. The flexible insert tube (1) according to claim 3, wherein the thickness (22) of the other layer (10) is at least 1.5 times, preferably at least twice the thickness of the first layer (8, 12).

5. The flexible insert tube (1) according to claim 1, wherein the thickness (22) of the other layer (10) is more than 50% of the total wall thickness (24) of the flexible insert tube (1).

6. The flexible insert tube (1) according to claim 1, wherein the other layer (10) is a nonwoven or felt layer.

7. The flexible insert tube (1) according to claim 1, wherein the other layer (10) has polyester or polypropylene, in particular wherein the other layer (10) consists of a polyester-containing and/or polypropylene-containing nonwoven or felt.

8. The flexible insert tube (1) according to claim 1, wherein the other layer (10) in the longitudinal direction and/or in the peripheral direction, relative to the longitudinal axis (6) of the flexible insert tube (1), has a lower tensile strength than the first layer (8, 12).

9. The flexible insert tube (1) according to claim 1, wherein the other layer (10) has less than 50% by weight fibers of an inorganic material, preferably free of inorganic fibers.

10. The flexible insert tube (1) according to claim 1, wherein the fibers of inorganic material are glass fibers.

11. The flexible insert tube (1) according to claim 1, wherein the first layer (8, 12) with fibers of inorganic material is formed by a woven fiber fabric or a fiber braid, preferably by a woven glass fiber fabric or a glass fiber braid.

12. The flexible insert tube (1) according to claim 1, wherein the layers (8, 10, 12) of the flexible insert tube (1) are impregnated with a reaction mass which can be cured by ultraviolet radiation.
